(19) United States
(12) Patent Application Publication
(10) Pub. No.: US 2025/0267132 A1
(43) Pub. Date: Aug. 21, 2025

(54) DATA SECURITY MEASURES FOR CYBERSECURITY THREATS

(71) Applicant: Tyco Fire & Security GmbH, Neuhausen am Rheinfall (CH)

(72) Inventor: Gaurav Singh, Varanasi (IN)

(21) Appl. No.: 19/054,660

(22) Filed: Feb. 14, 2025

Related U.S. Application Data
(60) Provisional application No. 63/556,126, filed on Feb. 21, 2024.

(51) Int. Cl. H04L 9/40

(52) U.S. Cl. CPC H04L 63/0442; H04L 63/0236; H04L 63/30

(57) ABSTRACT

Data security measures are provided. A method may include determining a status of an accessibility of a predefined host. The method may include determining that a data structure corresponds to controlled-access information. The method may include encrypting the data structure to secure the controlled-access information. The encryption may be responsive to the status indicating inaccessibility of the predefined host and the determination of the correspondence.

### CROSS-REFERENCE TO RELATED APPLICATION

This application claims the benefit of and priority to U.S. Provisional Patent Application No. 63/556,126, filed Feb. 21, 2024, the entire disclosure of which is incorporated by reference herein.

### BACKGROUND

One or more aspects of the present disclosure relate to data security. Particularly, some embodiments of the present disclosure relate to the securing controlled-access information based on a detection of a network location.

Ransomware and other data access attacks can encrypt, delete, transport, or otherwise render files or other data structures inaccessible. Organizations can maintain backup, failover, archive, or other versions of controlled-access information. However, copied instances of controlled-access information can be associated with public disclosure of non-public information, aid in reverse engineering or identification of other vulnerabilities, or otherwise contribute to enterprise risk.

### SUMMARY

According to an aspect of an example embodiment, method of digital rights management is provided. The method includes determining a status of an accessibility of a predefined host. The method includes determining that a data structure corresponds to controlled-access information. The method includes encrypting the data structure to secure the controlled-access information responsive to the status indicating inaccessibility of the predefined host and the determination of the correspondence.

In an example embodiment, determining the data structure corresponds to the controlled-access information includes comparing a file extension of the data structure to a predefined set of file extensions.

In an example embodiment, determining the data structure corresponds to the controlled-access information is based on a location of the data structure within a file structure.

In an example embodiment, determining the data structure corresponds to the controlled-access information is based on a comparison of a unique identifier of the data structure to a predefined list of unique identifiers.

In an example embodiment, the method includes sending an indication of the status indicating the inaccessibility of the predefined host to a predefined address, comprising a source of the indication.

In an example embodiment, the indication of the status indicating the inaccessibility of the predefined host includes an email message, and the predefined address corresponds to a law enforcement agency.

According to an aspect of an example embodiment, the method includes determining a status of an accessibility of a second predefined host. The encryption of the data structure is responsive to the determination of the inaccessibility of the second predefined host. The determination is responsive to the status indicating the inaccessibility of the predefined host.

In an example embodiment, the instructions are executed automatically.

In an example embodiment, determining the status of the accessibility of the predefined host includes sending a request for an indication of a presence of the predefined host and determining that a predefined time has elapsed from the request without receiving a response.

According to an aspect of an example embodiment, a system includes a first computing device and a second computing device. The first computing device is configured to provide an indication of a communicative connection with a first set of network interfaces. The second computing device is configured to determine a status of the communicative connection based on the receipt of the indication at a first network interface of the first set of network interfaces. The second computing device is configured to bypass instructions to secure a data structure responsive to a determination that the communicative connection is present. The second computing device is configured to execute the instructions responsive to a determination that the communicative connection is absent. The instructions can include instructions to secure the data structure.

In an example embodiment, the system is configured to encrypt the data structure according to an asymmetric encryption protocol to secure the data structure.

In an example embodiment, the second computing device is configured to encrypt the data structure with a public key. The public key can correspond to a private key of the first computing device.

In an example embodiment, the second computing device is configured to delete the data structure from a local memory to secure the data structure.

In an example embodiment, the first computing device is separated from a second set of network interfaces by a network firewall, the network firewall configured to firewall a network. The network includes the first computing device and the first set of network interfaces. The network firewall is configured to block one or more of (1) the indication of the communicative connection from the first computing device to the second set of network interfaces, or (2) a request from one or more of the second set of network interfaces to the first computing device.

According to an aspect of an example embodiment, a method is performed by a controller including one or more processors coupled with memory. The method includes receiving a first instruction to secure controlled-access information. The method includes establishing a communicative connection with a predefined host, responsive to the receipt of the first instruction. The method includes bypassing, responsive to the establishment of the communicative connection, second instructions accessible to the controller to secure a data structure. The second instructions include instructions to locate the data structure corresponding to the controlled-access information. The second instructions include instructions to replace the data structure with an encrypted data structure.

In an example embodiment, the data structure is local to the controller and a decryption key to decrypt the encrypted data structure is not accessible to the controller.

In an example embodiment, the method includes establishing, subsequent to bypassing the instructions, an absence of the communicative connection. The method can further include executing, responsive to the absence of the communicative connection, the second instructions.

In an example embodiment, the instructions to locate the data structure corresponding to the controlled-access information include instructions for comparing a file extension of the data structure to a predefined set of file extensions.

In an example embodiment, the method includes receiving prior to the receipt of the first instruction, a first encryption key to encrypt the data structure from the predefined host.

In an example embodiment, the first instruction is received automatically.

In an example embodiment, the first instruction is received incident to an execution of an executable file stored on a same storage media as the second instructions, and the second instructions to locate the data structure are based on a relative path between a location of the executable file and the data structure.

### BRIEF DESCRIPTION OF THE DRAWINGS

The above and other aspects and features of the present disclosure will become more apparent to those skilled in the art from the following detailed description of the example embodiments with reference to the accompanying drawings, in which:

FIG. 1 is a block diagram of an example computing environment within which aspects of the present disclosure may be implemented.

FIG. 2 is a block diagram of an example system for access management to resources in the computing environment of FIG. 1.

FIG. 3 is a block diagram of an example networked environment;

FIG. 4, a block diagram of an example system including a computing device;

FIG. 5 is a sequence diagram corresponding to data security measures, according to an embodiment of the present disclosure; and

FIG. 6 is a flow diagram of an example process or method for implementing data security measures, according to an embodiment of the present disclosure.

### DETAILED DESCRIPTION

Hereinafter, example embodiments will be described in more detail with reference to the accompanying drawings.

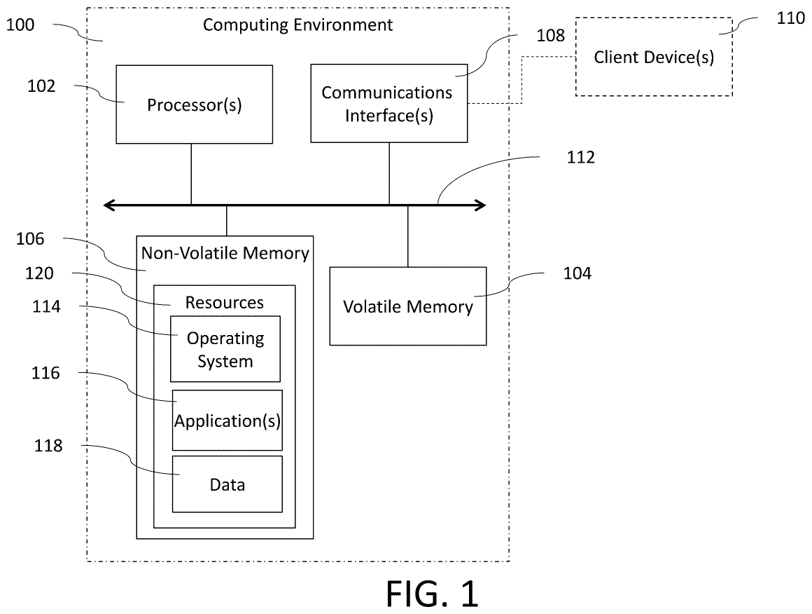

Referring now to FIG. 1, a computing environment 100 is shown within which some of the aspects of the present disclosure may be implemented. The computing environment 100 may include one or more processors 102, volatile memory 104 (e.g., random access memory (RAM)), non-volatile memory 106 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof, which may be referred to as a local memory) and one or more communications interfaces 108 which may also be referred to as a network interface, in the case of devices in network communication. Various client devices 110 (e.g., mobile devices, desktops, laptops, tablets, or other computing devices) may be configured to access the components included in the computing environment 100 via the communications interface 108 and through communication bus 112.

Non-volatile memory 106 stores operating system 114, one or more applications 116, and data 118 (collectively referred to as resources 120) such that, for example, computer instructions of operating system 114 and/or applications 116 are executed by processor(s) 102 out of volatile memory 104. In some embodiments, volatile memory 104 may include one or more types of RAM and/or a cache memory that may offer a faster response time than a main memory. Various elements of computing environment 100 may communicate via one or more communication buses, shown as communication bus 112.

The computing environment 100 (and client device 110) are shown merely as an example. Such components may be implemented as various computing devices including client devices, servers, networking devices etc., and may be implemented by any computing or processing environment and with any type of machine or set of machines that may have suitable hardware and/or software capable of operating as described herein. Processor(s) 102 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” may be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, general-purpose computers with associated memory, or other controllers. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data. In various embodiments, the components in the computing environment 100 may collectively be implemented within a server (or group of servers).

In various embodiments, one or more client devices 110 may be configured to access, for instance, applications 116 in the non-volatile memory 106 of the computing environment 100. Some of the applications 116 may be applications corresponding to the networked environment described herein. Other applications 116 may correspond to general enterprise systems. For instance, some applications 116 may correspond to human resources, and other applications 116 may correspond to the HVAC system. In various embodiments, at least one of the applications 116 may include or provide data (e.g., to a client device 110) corresponding to various aspects of the system. The client device 110 may be associated with a respective entity (e.g., an enterprise, such as a business, residence, or other organization or portion thereof), and the entity may include (e.g., own or operate) various networks, subnets, or the like. The applications 116 may include or provide such data corresponding to one or more entities (including the entity associated with a particular client device 110). The client devices 110, however, may be limited to accessing resources 120 corresponding to their respective entity.

The client device 110 may be configured to access the applications 116 by providing token(s) as log-in credentials, or according to a network map or routing implemented by various network devices. The client device(s) 110 may access the resources 120 within the computing environment 100 via a respective communications interface through communications interfaces 108. Communications interfaces 108 may include one or more interfaces to enable the client device(s) 110 to access a computer network, such as a Local Area Network (LAN), a Wide Area Network (WAN), a Personal Area Network (PAN), or the Internet through a variety of wired and/or wireless or cellular connections, upon which the resources 120 are available to the client device(s) 110.

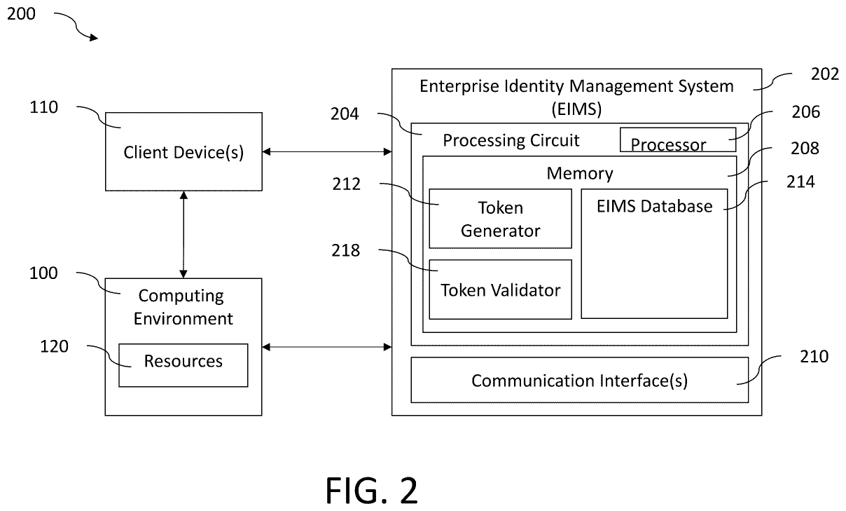

Referring to FIG. 2, a block diagram of a system 200 is shown for providing access to enterprise-specific resources, according to an illustrative embodiment. The system 200 may provide access to the resources 120 in the computing environment 100 depicted in FIG. 1. The system 200 is shown to include an enterprise identity management system (EIMS) 202, a client device 110, and a computing environment 100. The client device 110 and computing environment 100 may include aspects similar to those described above with reference to FIG. 1. As described in greater detail below, the EIMS 202 may be configured to generate token(s) for various client devices 110 to access resources 120 within the computing environment 100. The EIMS 202 may be configured to subsequently validate token(s) received by the computing environment 100 from the client device(s) 110. The EIMS 202 may be configured to provide the client device(s) 110 access to various resource(s) 120 responsive to validating the token, as described in greater detail below.

EIMS 202 may generally be designed or implemented to manage individual identities, their authentication, authorization, roles and privileges within or across system and enterprise boundaries and in various environments (including, for instance, the computing environment 100). EIMS 202 may include various components or features which limit access to specific applications, systems, components, data, environments, or other resources to authorized, authenticated users. EIMS 202 may include various components for onboarding new users, access control of existing users, and offboarding of users who are no longer authorized access some or all resources. In some embodiments, EIMS 202 may be incorporated into or be a component or aspect of various computing environments.

In various embodiments, EIMS 202 may be deployed on a dedicated computing device (such as a dedicated server or network appliance). The dedicated computing device may be located on-premises (e.g., within a corresponding building for the enterprise), or EIMS 202 may be deployed in the cloud. EIMS 202 may apply various policies or protocols which define which client device 110 (and corresponding users) are permitted to access specific resources, and what permissions such users may have with respect to those resources. The embodiments described herein may be used for managing access to enterprise resources, while managing customer, partner, supplier, and device access to its systems and ensuring security is a priority for the enterprise.

Some embodiments and deployments of EIMS 202 may include features for management of individual identities, their authentication, authorization, roles and/or privileges within or across system and enterprise boundaries (also referred to herein as access control). However, such EIMS 202 may not provide for multi-organization token generation, in some embodiments. In some embodiments, multi-organization token generation and/or access control may be performed by separate entities. Furthermore, device registration and management and access control may be performed by separate entities (which may even occur on a resource-by-resource basis). Since these systems work independently of one another and there is no direct integration, such systems collectively may cause inefficiencies and increase downtime.

Furthermore, some deployments of EIMS 202 may not include or provide for impersonation features. Such features may be used for diagnostics or troubleshooting. Where EIMS 202 and impersonation features are separated, such embodiments may also decrease efficiency and increase downtime.

EIMS 202 is shown to include a processing circuit 204 including a processor 206 and/or memory 208. The processor 206 may be the same as or similar in some aspects to processor(s) 102 described above with reference to FIG. 1. Similarly, memory 208 may be the same as or similar in some aspects to memory described above with reference to FIG. 1. Hence, memory 208 may be or include volatile and/or non-volatile memory.

EIMS 202 is shown to include a communications interface 210. The communications interface 210 may provide for or enable communication between the computing environment and/or client device(s) 110. Thus, the communications interface 108 may be communicably coupled to the computing environment 100 and/or client device(s) 110. The communications interface 210 may be similar in at least some aspects to communications interface(s) 108 described above with reference to FIG. 1.

The memory 208 is shown to include a token generator 212. The token generator 212 may be or include any device, component, agent, application, and so forth designed or implemented to generate a token specific for client device(s) 110, and/or resources 120. The token may be a data packet or structure which is uniquely associated with the particular entity. In various embodiments, the tokens may be cryptographically secured (e.g., encrypted according to various cryptographic methods and contexts). The token may be shared with the client device(s) 110, components within the computing environment 100 (e.g., via respective communications interface(s) 108, 210), and so forth.

In some embodiments, a client device 110 may be configured to request a token. In some embodiments, an application 116 (e.g., a processor 102 configured to execute the application 116) may be configured to request a token. In some embodiments, the request may include various credentials. For instance, where a client device 110 requests a token, the request may include a username, password, organization name, PIN, and/or other identifiers which may be used for authenticating a particular node. Where the application 116 requests a token (for instance, when the application is attempting to run and complete a scheduled job), the request may include a client identifier and client secret.

The token generator 212 may be configured to generate a token responsive to receiving the request. The token generator 212 may be configured to authenticate/authorize a user (e.g., using the client device 110) responsive to receiving the request from the client device 110. The token generator 212 may be configured to authenticate the user based on the username, password, organization name, PIN, etc.

The token generator 212 may be configured to compare data stored in the EIMS database 214 with the credentials received in the request (e.g., the username, password, organization name, etc.). The token generator 212 may be configured to cross-reference the credentials with each or a subset of entries in the EIMS database 214 to identify a matching entry. The token generator 212 may be configured to authenticate the user responsive to identifying a matching entry in the EIMS database 214.

In various embodiments, the token generator 212 may be configured to generate a time-bound token. The time-bound token may be a token which is valid for a limited duration (e.g., a number of minutes, hours, days, etc.). The duration may be set by the enterprise, by the administrator, by the user, etc. The time-bound token may be active for a limited duration, and may have other security settings. For instance, the time-bound token may provide limited access to resources 120. The time-bound token may provide read-only access to the resources 120. According to such embodiments, the administrator may be configured to access resources 120 as a specific user and see resources 120 in the same manner as the specific user would see the same resources 120, though the administrator may not be permitted to modify or change any resources 120. In some embodiments, the time-bound token may provide the administrator full access to whatever resources the user is permitted to access for the limited duration. Hence, the administrator may be configured to access resource 120, see resources 120, and/or interact with resources 120 as the specific user for a limited duration.

The token generator 212 may be configured to automatically generate a token for each registered entity. The token generator 212 may be configured to identify entities as registered upon enrollment (e.g., by an enterprise administrator via a respective client device, for instance). The token generator 212 may be configured to provide the entity (e.g., via the communications interface 210) the generated token. The token may indicate which resources the entity is permitted to access.

In some embodiments, the token generator 212 may be configured to store data corresponding to the generated tokens in the entries on the EIMS database 214. For instance, where the token generator 212 generates a token for a particular client device 110, the token generator 212 may be configured to store a copy of the token (e.g., in an entry of the EIMS database 214) associated with the client device 110. The stored copy or other data corresponding to the token may be used for subsequently validating the token, as described in greater detail below.

In some embodiments, the resource 120 may be configured to request a token from the token generator 212. For instance, the processor 102 executing the application 116 may be configured to request a multi-organization token. The multi-organization token may be a resource-specific token which includes a plurality of tokens associated with various entities. The processor 102 may request the multi-organization token responsive to the resource having a scheduled job. The processor 102 may be configured to request the multi-organization token from the token generator 212 when the processor 102 is scheduled to perform the job. As described above, the request may include the client identifier and client secret. The client identifier and client secret may be uniquely associated with a particular resource 120. The client identifier and client secret may be generated by the EIMS 202 when the resource is registered with EIMS 202 (e.g., by an administrator at enrollment).

The token generator 212 may be configured to identify the client identifier and client secret from the resource 120 (e.g., from the processor 102). The token generator 212 may be configured to cross-reference the client identifier and client secret received in the request with data included in the EIMS database 214. EIMS database 214 may be configured to store the client identifier and client secret for each resource 120 when the resource registers with EIMS 202. The token generator 212 may determine the identity of the resource 120 based on the client identifier and client secret. Responsive to validating the client identifier and client secret, the token generator 212 may be configured to identify which entities are active for the corresponding resource 120. The token generator 212 may be configured to compile a list of tokens for the active entities by extracting, copying, duplicating, or otherwise reproducing the tokens for the entities which are identified as active for the corresponding resource 120. The token generator 212 may be configured to generate a multi-organization token which includes each of the tokens included in the list. Hence, the multi-organization token may include the tokens of tenants which are determined to be active with a particular resource.

The token generator 212 may be configured to provide generated token(s) to the source which requested the token. The token generator 212 may be configured to provide the token(s) through the communications interface(s) 210 to the processor 102 and/or client device(s) 110. As described in greater detail below, the tokens may be received (e.g., through a resource 120) by EIMS 202. EIMS 202 may use the tokens to determine that the token is valid and the client device 110 is permitted to access the particular resource 120.

The memory 208 is shown to include a token validator 218. The token validator 218 may be or include any device, component, agent, application, and so forth designed or implemented to validate tokens received from resource(s) 120. Generally speaking, the token validator 218 may be configured to validate the tokens received from the resource(s) 120, and determine whether the client device 110 is permitted to access the particular resource 120.

The client device 110 may be configured to provide a token to the communications interface 108 of the computing environment 100. The client device 110 may be configured to provide the token when a particular user is requesting access to a particular resource 120. In some embodiments, an administrator may provide the token on behalf of a particular user. In such embodiments, the administrator may be “impersonating” the user by providing a token which is associated with the user. In various embodiments, the client device 110 may provide the token to the communications interface 108 through an application program interface (API). The API may be or include a set of instructions or protocols which define or specify the communications structure between the client device 110 and particular resources 120. When the processor 102 determines that a token is received, the processor 102 may route the token to EIMS 202 for validation.

In some embodiments, when a resource 120 has a scheduled job, the processor 102 may communicate one of the plurality of tokens in the resource-specific token to EIMS 202. As described in greater detail below, EIMS 202 may validate the token and provide an indication that that the entity which transmitted the token is permitted to access the resource 120. The processor 102 may run the scheduled job, and communicate another token to EIMS 202. The processor 102 may iteratively communicate tokens until the processor 102 has performed all scheduled jobs for the particular resource 120.

The token validator 218 may be configured to validate the token received from the resource 120. As stated above, the EIMS database 214 may be configured to store copies or data corresponding to tokens generated by the token generator 212. The token validator 218 may be configured to cross-reference the token received from the resource 120 with entries in the EIMS database 214 to determine whether the token is valid (e.g., matches a token in the EIMS database 214, corresponds to data in the EIMS database 214, etc.). The token validator 218 may be configured to determine that the token is valid based on the cross-referencing.

The token validator 218 may be configured to determine which resources 120 correspond to the token received by the token validator 218. The token validator 218 may be configured to determine which resources the client device 110 is permitted to access based on the token. The token validator 218 may be configured to identify the entry in the EIMS database 214 which included the data used for validating the token. The entry may include resources 120 which are accessible by the entity corresponding to the token. The token validator 218 may be configured to determine whether the resource 120 which provided the token to the token validator 218 is accessible by the entity corresponding to the token. The token validator 218 may be configured to provide an indication to the resource 120 which indicates 1) whether the token is valid and 2) whether the entity corresponding to the token is permitted to access the resource 120. The processor 102 may provide (or deny) access to the resource based on the indication from the token validator 218. As stated above, the illustrative embodiment is an example of a system 200 to provide access to various enterprise resources 120, as is not intended to be limiting. The examples of data security measures disclosed hereinafter may be implemented within such an example system 200, or in various other systems. Further, according to various embodiments, one or more computing devices may operate alternatively or simultaneously as, for example, a client device 110, or another computing device configured to provide a resource 120 thereto. Further, some computing device can retrieve resources beyond an authorization according to various techniques, wherein the resources can include information that is not intended for public disclosure, and may be classified, tagged, or otherwise identifiable as controlled-access information. For example, resources may include any of the information stored in one or more data repositories of the various computing devices of a system.

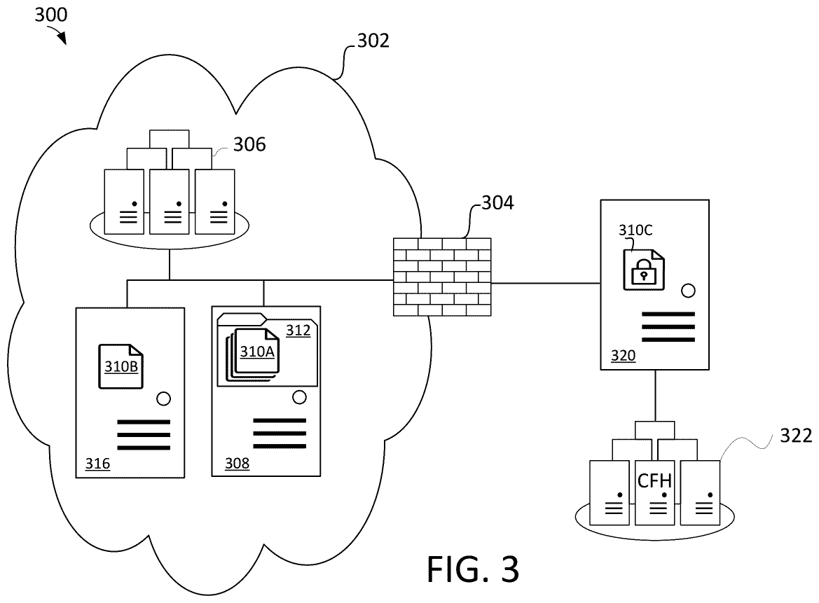

Referring now to FIG. 3, a block diagram of a network environment 300 is shown, according to some embodiments. The network environment 300 includes a network, such as the depicted enterprise network 302 (e.g., local area network or wide area network). The enterprise network 302 is presented as a logical network, and may include devices locally proximal to each other, or devices which are physically remote, as in the case of a virtual private network (VPN). The enterprise network 302 may be bounded from other networks (e.g., the Internet, other private networks, or other subnets of the enterprise network 302) by one or more firewall 304 devices. The firewall 304 may be or include any device, component, element, processor, computer, or other various combinations of hardware configured to analyze messages at a network interface to selectively pass the messages through the interface. The firewall 304 may be configured with rules permitting or denying access.

Some firewalls 304 may implement restrictive or permissive rules. For example, a restrictive rule may correspond to the firewall 304 blocking traffic on a specified port. A permissive rule may correspond to the firewall 304 not blocking access within permit a certain address range. Firewalls 304 may have default restrictive or permissive access. For example, a firewall 304 may permit all messages that do not correspond to a rule, or restrict all messages that do not correspond to a rule. Various combinations of restrictive and permissive rules may be implemented according to a desired application. Although pictured along a boundary of the enterprise network 302, firewalls 304 may be disposed at various network interfaces and between various devices. For example, each of the connections described herein may include a firewall 304 along the connection. In some instances, the firewall 304 may discriminate between a local and global address. For example, a local address (e.g., IP address) corresponding to another device of the enterprise network 302 may vary from an address for another internet connected device, such that the firewall 304 can route traffic according to a local subnet. That is, the firewall 304 may include or be implemented by a routing table or a router.

A host device 306 of the enterprise network 302 may connect to various other devices of the enterprise network 302. For example, the host device 306 may be assigned or otherwise associated with a static internet protocol (IP) address, hostname, or other identifier which may be employed by another device to determine an accessibility of the host device 306. The host device 306, like other computing devices depicted herein (e.g., first computing device 308, second computing device 316, or remote device 320) may include one or more servers, clusters, controllers, or so forth. For example, the host device 306, like other devices of the network may include multiple instances or controllers to load-balance, provide redundancy, or provide horizontal scaling (of various services or microservices). The host device 306 may be accessible to at least a first computing device 308 of the enterprise network 302. In some embodiments, the host device 306 may be accessible to all devices of the enterprise network 302. The host device 306 may be inaccessible to one or more devices intermediated from the enterprise network 302 by the firewall 304. Such devices remote from the enterprise network 302 may be referred to as remote devices 320.

The first computing device 308 may include or interface with a file structure 312 containing various data structures 310A (e.g., files, linked lists, buffers, or memory registers). At least some of those data structures 310A may include controlled-access information. For example, controlled-access information may refer to files or contents thereof which are not intended for access, modification, distribution, or other presence away from the enterprise network 302.

Various instances of the data structures 310A, 310B, 310C (referred to, generally, as data structures 310) may be provided across an enterprise. For example, the file structure 312 of the first computing device 308 may include the first instance of the data structure 310A. A second computing device 316 may include a second instance of the data structure 310B. The second instance of the data structure 310B may be identical to or vary from the first instance of the data structure 310A. For example, the second instance of the data structure 310B may be a base file for an incremental backup. In some instances, the second computing device 316 may include or omit various other data structures 310A of a file structure 312 of the first computing device 308. Either or both of the first computing device 308 and the second computing device 316 may be configured to secure access to data structures 310 based on a status of accessibility of the host device 306. For example, the file structure 312 can further include instructions to secure the data structure, such as via encryption, deletion, or notification. Thus, upon an absence of the host device 306, the first computing device 308 may be configured to secure the controlled-access information of the first instance of the data structure 310A.

In the event that the first computing device 308, or a file structure 312 or data structure 310A thereof, is transported away from the enterprise network 302, the other instructions in the file structure 312 may be executed to secure the controlled-access information. For example, the execution of the instructions may cause a controller to detect an accessibility of the host device 306, and perform an action to secure at least one data structure 310C. For example, the first computing device 308 may include instructions to secure the information via deletion, encryption, or other data transformations of the controlled-access information, or via generation of a message to a cyber-forensic hub 322 (e.g., a law enforcement agency). The message may include, for example, an email generated according to a simple mail transfer protocol, (SMTP). In some embodiments, as depicted, one or more components (e.g., an SMTP addressable portion) of the cyber-forensic hub 322 may be remote from the enterprise network 302. In some embodiments, at least a portion of the cyber-forensic hub 322 may be disposed on the enterprise network 302. In some embodiments, the instructions may determine a location and take a further action based on the determined location. For example, the instructions may include instances of instructions geofenced for particular geographic regions (e.g., corresponding to a lawful action in the geofenced region, or an address corresponding to a cyber-forensic hub 322 for the geographic region).

The instructions to secure the information may be stored in a same data structure 310A or file structure 312 as the controlled-access information, such that upon an exfiltration of data from the first computing device 308 or other transportation of such a file structure 312 away from the network (e.g., a physical removal of the first computing device 308), the instructions may be executed to secure such information. For example, wherein an instance of the file structure 312 is transported (e.g., copied) to the remote device 320, such instructions may encrypt the files to generate a third instance of the data structure 310C in which controlled-access information is not accessible (or not readily accessible) by the remote device 320. In some embodiments, upon a restoration of an accessibility of the host device 306 (e.g., a cessation of a network connection issue), the host device 306 may provide a key to decrypt or otherwise restore at least a portion of the file structure 312.

The first computing device 308 (to include, as indicated above, a remote device 320 storing at least a portion of a file structure 312 from the first computing device 308) may determine a presence or absence of the enterprise network 302 by determining a status of a host device 306 (e.g., an accessibility or non-accessibility thereof). The determination of the status may include establishing a communicative connection with the host device 306 to determine a presence thereof, receipt of a broadcast or other message from the host device 306, or another determination that the host device 306 is accessible to the first computing device 308 or other device in network communication therewith. The firewall 304 may filter messages between the host device 306 such that a remote device 320 determining a status of the host device 306 may determine that the host device 306 is inaccessible thereto, whereupon the execution of the instructions can secure controlled-access information. Determinations of inaccessibility can be determined according to an expiration of a watchdog or determination that a predefined time has elapsed from the request without receiving a response.

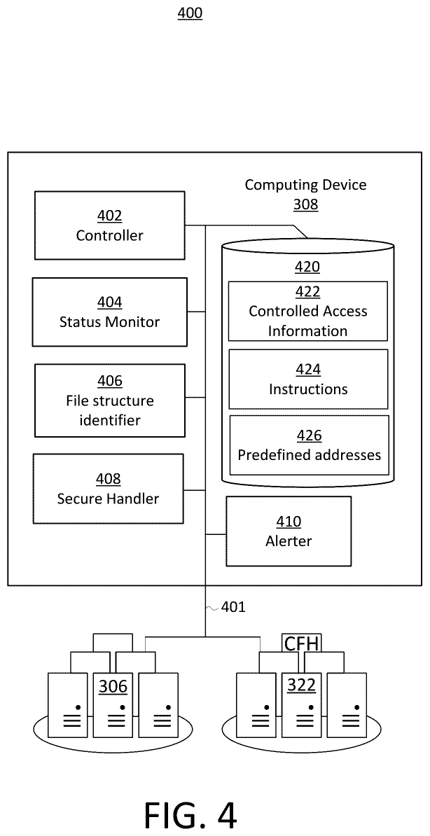

Referring now to FIG. 4, a block diagram of an example system 400 including a computing device is provided, according to some embodiments. The computing device can be the first computing device 308 of FIG. 3, as depicted, or another computing device, such as a remote device 320 including at least a portion of a file structure 312 exfiltrated from the first computing device 308. That is, in some embodiments, the computing device can be a remote device 320 which is not communicatively coupled with a host device 306 of an enterprise network 302. Thus, various references to the first computing device 308, or the various elements thereof as provided herein, can be applied to any number of remote devices 320.

The system 400 can include or interface with a network 401 to exchange information between various computing devices thereof, or in network communication therewith. The network 401 can include computer networks such as Ethernet networks, controller area networks (CAN) 401, Peripheral Component Interconnect Express (PCIe), the Internet, local, wide, metro, or other area networks 401, intranets, cellular networks 401, satellite networks 401, and other communication networks 401 such as Bluetooth, or data mobile telephone networks 401. The network 401 can be public or private, or include public and private portions (e.g., the enterprise network 302 and the Internet). The various elements of the system 400 can communicate over the network 401. Various instances of information exchanged between devices herein can refer to changes within a memory accessible to one or more components, or between devices, via a network interface corresponding to each device. That is, each device can include one or more network interfaces (e.g., a set of network interfaces) to communicate with further devices.

The first computing device 308 can communicatively couple with other devices, (e.g., one or more host devices 306, remote devices 320, or so forth) over the network 401. In some instances, the communicative connection between the first computing device 308 and the host device 306 can be interrupted or absent, over at least one port, time, or other link portion so as to interrupt an operative connection therebetween. For example, a network outage between the first computing device 308 and the host device 306 or a routing instruction of a firewall 304 (not depicted) disposed between the first computing device 308 and the host device 306 can interrupt such an operative connection.

The first computing device 308 can include or interface with at least one controller 402 to execute instructions to implement various methods or operations described herein. The first computing device 308 can include or interface with at least one status monitor 404 to determine a status of a host device 306. The first computing device 308 can include or interface with at least one file structure identifier 406 to determine a location of one or more data structures accessible to the controller 402. The first computing device 308 can include or interface with at least one secure handler 408 to instantiate an operation to secure the one or more file structures, such as via encryption or deletion. The first computing device 308 can include or interface with at least one alerter 410 to generate a notification indicative of a storage location of the one or more data structures 310.

The system 400 can include at least one data repository 420. The status monitor 404, file structure identifier 406, secure handler 408, or alerter 410 can each include or interface with at least one processing unit or other logic device such as programmable logic array engine, or module configured to communicate with the data repository 420 or database (e.g., the controller 402). Each device connected to a network 401 can include at least one instance of a controller 402. The controller 402, status monitor 404, file structure identifier 406, secure handler 408, or alerter 410 can be separate components, a single component, or part of the first computing device 308. The first computing device 308 can include hardware elements, such as one or more processors, logic devices, or circuits, some of which may be, be accessible to, or be non-addressable by, the controller 402. For example, the system 400 can include one or more components or structures of functionality of computing devices depicted in FIG. 1.

The data repository 420 can include one or more local or distributed databases, and can include a database management system. The data repository 420 can include computer data storage or memory and can store one or more data structures 310, such as controlled-access information 422, instructions 424 to secure the controlled-access information 422, a predefined address 426, or other data elements such as data structures 310 corresponding to non-controlled-access information.

Controlled-access information 422 may refer to or include any information which is restricted from public release. For example, the controlled-access information 422 can include information determined to have a security risk in excess of a threshold. Any data which is not controlled-access information can be referred to as non-controlled-access information. The data repository 420 can include various identifiers to distinguish the controlled-access information 422 from the non-controlled-access information, as is further discussed with regard to the file structure identifier 406. For example, the controlled-access information 422 of the data repository 420 can be indicated by a list of predefined files, file types, or other indicia of access control (such as tags, flags, or other indicia which defines whether or not information is controlled-access information 422 or non-controlled-access information).

An executable file can include instructions 424 to secure the controlled-access information 422. Upon execution of the file, the instructions 424 can determine an accessibility of a host device 306, locate controlled-access information 422, or secure the controlled-access information 422. Securing the controlled-access information can include, for example, encryption or deletion of such information, generation of a notification indicative of a location of the information, or so forth). In some embodiments, the instructions 424 can include multiple instructions 424 corresponding to multiple device types. For example, a first set of instructions 424 can correspond to a windows device, a second set of instructions 424 can correspond to a Unix device, and so on. In some embodiments, the instructions 424 are configured for automatic execution on at least some devices (e.g., located in a startup folder for an operating system or application). In some embodiments, the instructions 424 are configured for execution via a manual action (e.g., opening of a file including macros). In some embodiments, the instructions 424 are stored in a predefined location and configured for execution upon a receipt of further instructions, such as further instructions received from a cyber-forensic hub 322 in network communication with the first computing device (e.g., over the Internet).

A predefined address 426 can refer to or include an address corresponding to a host device 306 or for notification messages generated by the alerter 410. For example, the data repository 420 can include a predefined address 426 corresponding to a first host device 306 and a second host device 306 (e.g., a failover or secondary server). The predefined address 426 for the host device 306 can include an IP address, host name, uniform resource locator (URL) address, port number, or other predefined address 426. The predefined address 426 may be resolvable locally, by the first computing device 308, or by another device (e.g., router or domain name service). A firewall 304 associated with the enterprise network 302 can be configured to filter communications associated with the predefined address 426, such that a message sent from outside the enterprise network 302 does not reach the host device 306, or a reply from the host device 306 does not pass over a boundary between the enterprise network 302 and another network (e.g., the Internet). In some embodiments, the firewall 304 can selectively pass messages between the host device 306 and a device external to the network, such as based on a whitelist, blocklist, or admin user selection.

The data repository 420 can include a predefined address 426 corresponding to the alerter 410. For example, the predefined address 426 corresponding to the alerter 410 can be for one or more devices on the enterprise network 302 (e.g., at the firewall 304, inside of the firewall 304, or in a network demilitarized zone (DMZ) along a network boundary). In some embodiments, the predefined address 426 can correspond to a public facing device, accessible via the internet (e.g., an email server). For example, the predefined address 426 can correspond to a network security team or a law enforcement agency (e.g., the cyber-forensic hub 322). In some embodiments, a firewall 304 associated with the enterprise network 302 can be configured to filter outgoing messages originating from the network and addressed to a cyber-forensic hub 322 (e.g., to reduce nuisance faults from internal network outages). A recipient corresponding to the predefined address 426 can store instructions 424 to respond to a receipt of a notification by tracing a source of the email, or taking further actions such as distributing computer-readable instructions 424 configured for execution by the controller 402 or another processor associated with a computing device. In some embodiments, such instructions 424 are configured for execution at the first computing device 308, automatically (e.g., without a user interaction, or based on a user interaction associated with executing other instructions 424, such as a selection of an element of a webpage, or an opening of a file including macros or other automatically executing instructions 424).

The system 400 may include at least one controller 402. The controller 402 may include or interface with one or more processors and memory. The processor may be implemented as a specific purpose processor, an application specific integrated circuit (ASIC), one or more field programmable gate arrays (FPGAs), a group of processing components, or other suitable electronic processing components, including those described at FIG. 1. The processors and memory may be implemented using one or more devices, such as devices in a client-server implementation. The memory may include one or more devices (e.g., random access memory (RAM), read-only memory (ROM), flash memory, or hard disk storage) for storing data and computer code for completing and facilitating the various user or client processes, layers, and modules. The memory may be or include volatile memory or non-volatile memory and may include database components, object code components, script components, or any other type of information structure for supporting the various activities and information structures of the concepts disclosed herein. The memory may be communicably connected to the processor and include computer code or instruction circuits for executing one or more processes described herein. Such instructions may be stored on non-volatile memory. The memory may include various circuits, software engines, and/or modules that cause the processor to execute the systems and methods described herein, such as to cause the communication or processing of data.

The controller 402 may include or be coupled with communications electronics (e.g., a network interface). The communications electronics may conduct wired and/or wireless communications via the network 401 or other communication links. For example, the communications electronics may include one or more wired (e.g., Ethernet, PCIe, or AXI) or wireless transceivers (e.g., a Wi-Fi transceiver, a Bluetooth transceiver, an NFC transceiver, or a cellular transceiver). The controller 402 may be in network communication or otherwise communicatively coupled with the status monitor 404, file structure identifier 406, secure handler 408, or alerter 410. The controller 402 may cause one or more operations disclosed by employing another element of the first computing device 308. For example, operations disclosed by other elements of the system may be initiated, scheduled, or otherwise controlled by the controller 402.

The system 400 may include at least one status monitor 404. The status monitor 404 can determine a status (e.g., accessibility or inaccessibility) of a host device 306 with respect to the first computing device 308. The status monitor 404 can determine the status based on a message and reply. For example, the message and reply can include an internet control message protocol (ICMP) message, such as a ping echo request and corresponding ping echo reply. The status monitor 404 can determine the status responsive to a receipt of a periodic message (e.g., broadcast message from the host device 306). For example, the status monitor 404 can service a timer upon receipt of a message from the host device 306. Upon an expiration of the timer, the status monitor 404 can provide an indication of inaccessibility of the host device 306 to, for example, the secure handler 408.

In some embodiments, the status monitor 404 can communicate with multiple host devices 306. For example, the status monitor 404 can determine that a first host device 306 is inaccessible, and determine a status of a second host device 306. The second host device 306 can be disposed on the enterprise network 302, or accessible to public facing devices (e.g., on the internet). For example, placement of a host device 306 on the internet can delay securing (e.g., deletion or encryption) of data structures 310, or prevent securing of data structures 310 (e.g., where a public use of such data structures is desired or encryption or deletion of data structures 310 is not desired).

In some embodiments, the status monitor 404 can establish a secure connection (e.g., tunnel) with one or more host devices 306, or otherwise exchange one or more tokens between the host device 306 and the first computing device 308 (e.g., according to the operations discussed with regard to FIG. 2). For example, the tokens can identify the first computing device 308, where the host device 306 can determine an authorization of the identity of the first computing device 308 prior to providing a token, message, or other information to cause the status monitor 404 to determine an accessibility of the host device 306. That is, the determination of accessibility can include a provision of an identity or authorization (e.g., key or token).

The system 400 can include at least one file structure identifier 406. The file structure identifier 406 can determine an identity or location of one or more data structures 310 including controlled-access information 422 within a file structure 312. The file structure identifier 406 can determine the identity or location of the data structures 310 within various media accessible to the controller 402. For example, one or more files can be located at a predefined position within a file structure 312. The predefined position can include, for example, a memory location or a name of a location within a file structure 312. The predefined position can include a relative path or other location, such as a relative address location (e.g., range) or a relative position within a folder structure (e.g., within two hierarchical levels of an execution location of instructions 424 executed by the controller 402).

In some embodiments, the file structure identifier 406 can identify one or more data structures 310 according to a type, size, identifier, or other attribute. The file structure identifier 406 can identity the data structures 310 in a local memory, or data structures 310 present in network attached storage. The local memory can include a hard drive, solid state drive, or other device housed within a same PC case, server rack, or other physical housing. An identifier for a data structure 310 can include a unique or non-unique identifier. For example, the file structure identifier 406 can store a file name or other identifier (e.g., cyclic redundancy check (CRC) value, secure hash algorithm (SHA), message digest algorithm (MDX), etc.) The file structure identifier 406 can determine a data structure 310 includes or otherwise corresponds to controlled-access information 422 based on a file name, file path, or file extension. The file structure identifier 406 can detect one or more file types accessible to a controller 402 which are associated with controlled-access information 422. For example, the file structure identifier 406 can compare a file extension to a predefined set of file extensions (e.g., DOC, .DOCX, .XLSX, or .CSV). According to various embodiments, the file structure identifier 406 can employ one or more of the identification operations disclosed herein. For example, in some embodiments, the file structure identifier 406 can identify all files of a predefined file type. In some embodiments, the file structure identifier 406 can identify files matching according to a SHA-512 or other cryptographically secure identifier, by comparing a predefined identifier to a set of predefined identifiers (sometimes referred to as predefined list of unique identifiers). That is, the file structure identifier 406 can be configured to be underinclusive (e.g., fail to detect files or other data structures which have been modified since a most recent indexing or which are not indexed as including controlled-access information 422, via an index of the data repository 420), or overinclusive (e.g., identify files or other data structures which do not include controlled-access information 422 based on a file extension alone).

The system 400 can include at least one secure handler 408. The secure handler 408 can execute an operation to secure one or more data structures 310 of a file structure 312. For example, the secure handler 408 can execute an operation of the status monitor 404 to determine the availability of the host device 306 or an operation of the file structure identifier 406 to identify one or more data structures 310. In some embodiments, the secure handler 408 can operate automatically, without user interaction. For example, the secure handler 408 can include an executable file disposed in a location to be executed by the controller 402 (e.g., in a startup folder, registry, on same storage media, or the like). In some embodiments, the secure handler 408 can include a portion of the instructions 424 provided to the controller 402 via an email attachment, web browser, or file sharing network. In some embodiments, such an executable file can operate without a user action, or without a user action otherwise associated with executing the secure handler 408 (e.g., opening a file including automatically executable macros or other instructions 424). In some embodiments, a user action associated with navigation of a webpage or a selection of an email can cause the secure handler 408 to initiate an operation. For example, the executable file can originate from (or execute responsive to) instructions 424 originating from a cyber-forensic hub 322 (e.g., law enforcement agency).

The secure handler 408 can operate based on a status of the host device 306 and the data structures 310 identified by the file structure identifier 406. For example, the secure handler 408 can bypass instructions 424 to secure a data structure 310 based on an indication that a communicative connection with the host device 306 is present, or based on an indication that no data structures 310 are identified by the file structure identifier 406. Conversely, the secure handler 408 can execute instructions 424 to secure a data structure 310 based on an indication that a communicative connection with the host device 306 is absent, or based on an indication that one or more data structures 310 are identified by the file structure identifier 406 as including controlled-access information 422.

The secure handler 408 can secure one or more data structures identified by the file structure identifier 406. For example, the secure handler 408 can encrypt the data structures 310, delete the data structures, tokenize one or more elements of the data structure, actuate a digital rights management (DRM) control, or take another action (e.g., cause the alerter 410 to generate a notification associated with the data structure 310). Referring again to encryption of data structures 310 corresponding to (e.g., including) controlled-access information 422, the secure handler 408 can encrypt the data structure 310 according to various encryption protocols to replace the data structure 310 with an encrypted data structure 310C. In some embodiments, the secure handler 408 can encrypt the data structure 310 according to a symmetric key. Thereafter, the secure handler can delete or otherwise secure the key. In some embodiments, the secure handler 408 can encrypt the data structure 310 according to an asymmetric encryption protocol. For example, the secure handler 408 can retrieve (e.g., from the data repository 420) a public key of a public-private key pair. The private key may be stored by, another device of the enterprise network 302 (e.g., the host device 306), or otherwise in a location which is not accessible to the controller 402.

In some embodiments, the secure handler 408 can receive an instruction 424 from a host device 306 to decrypt a data structure 310. For example, the secure handler 408 can receive a message, from the host device 306 including the private key to decrypt the data structure 310 or otherwise restore the data structure 310 to a state prior to securing the data structure 310. For example, responsive to an intermittent network outage, various instances of secure handlers 408 can encrypt files on various network devices. Upon a restoration of network connectivity, the host device 306 can provide one or more private keys, and cause the various network devices to change a public key (e.g., by providing an updated public key corresponding to a second private key or by causing the various network devices to increment an active public key to a second active public key pre-stored on the various devices). In some embodiments, the various network devices and the host device 306 can exchange data structures 310 such that the private key of the host device 306 remains private.

The system 400 can include at least one alerter 410. The alerter 410 can generate a notification of an accessibility of the host device 306 with respect to another computing device. For example, various computing devices (e.g., the first computing device 308, firewall 304 (sometimes referred to as a network firewall 304, without limiting effect), remote devices 320, etc.) can include an instance of the alerter 410. Instructions 424 corresponding to the alerter 410 can be stored in a same file structure 312 as the one or more data structures 310 including the controlled-access information 422. Thus, any instantiations of other aspects of the present disclosure can further cause an instantiation of an alerter instance 410, (or be substituted for an instantiation of an alerter instance 410).

The alerter 410 can generate a message for provision to a predefined address 426. For example, the alerter 410 can generate a simple message system (SMS), email (e.g., SMTP), or other message. In some embodiments, the message can include a data payload of any information accessible to a controller 402 in network communication with the alerter 410. In some embodiments, the message can omit payload data. For example, the alerter 410 can generate an empty email message via SMTP, wherein the empty email message lacks a body, but includes header information. The alerter 410 can transmit or otherwise cause the message to be converted to the predefined address 426. Such a message may be employed, by a recipient thereof, to determine a source of the message. For example, a (logical or physical) network location associated with of potentially controlled-access information 422, which is away from the enterprise network 302 can be determined. In some embodiments (e.g., corresponding to one or more geographic locations, the alerter 410 can cause the message to be sent without encryption, deletion, or other securing of data structures 310).

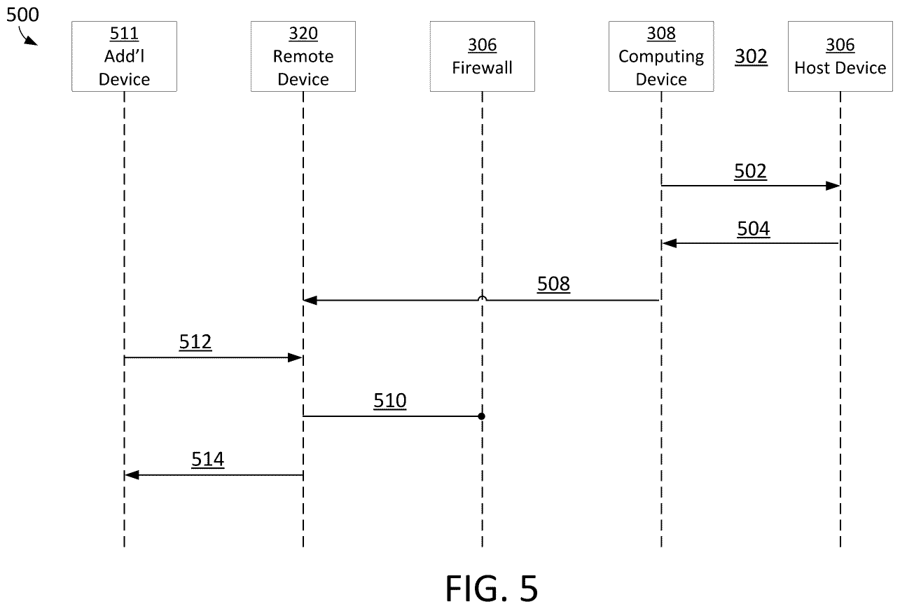

Referring now to FIG. 5, a sequence diagram 500 is provided corresponding to data security measures, according to some embodiments of the present disclosure. Like other aspects of the present disclosure, the sequence diagram 500 is an illustrative example, which can be modified according to the various disclosures provided herein. A first computing device 308 can provide a first message 502 to one or more host devices 306. The first computing device 308 and the host device 306 can be on a same network (e.g., the enterprise network 302 of FIG. 3). The host device 306 can provide a reply 504 to the first message 502. The first computing device 308 can determine, based on the receipt of the reply 504, that the host device 306 is accessible. Based on the determination of accessibility, the host device 306 can bypass instructions 424 to secure a data structure 310 stored thereon.

A data exfiltration event 508 can copy, relocate, or otherwise transport at least a portion of a file structure 312 away from the network including the first computing device 308 and the host device 306, to the remote device 320. The remote device 320 can be separated from the network by as firewall 304. Although the first computing device 308 or another device can store a backup of the exfiltrated data, the exfiltrated data may include controlled-access information 422 which is not intended for public disclosure. Instructions 424 to secure the data can be stored along with the controlled-access information 422 (e.g., in a same file structure 312, in a same logical or physical partition, or otherwise operatively coupled thereto). In some embodiments, the instructions 424 can be configured to automatically execute, to cause a controller 402 of the remote device 320 to determine an accessibility of the host device 306 (e.g., via a second message 510), whereupon a controller 402 of the remote device 320 can determine that the host device 306 is inaccessible. For example, the second message 510 can be misaddressed due to a network location, or filtered by the firewall 304.

In some instances, the instructions 424 may be stored on a storage medium which does not host an operating system, or is otherwise not configured for execution by a controller 402 or application of the remote device 320. However, an additional computing device 511, can deliver further instructions 512 to execute stored instructions 424 on the remote device 320 (e.g., the stored instructions 424 which were exfiltrated along with the controlled-access information 422). The additional computing device 511 may be, in various embodiments, within a same enterprise network 302 as the host device 306 and the first computing device 308, or away therefrom. In some embodiments, the additional computing device 511 can include a device of a cyber-forensic hub 322 which may be authorized by or otherwise corresponding to a law enforcement agency. The additional computing device 511 can deliver the further instructions 512 via email, web browser, or other connection over a public or private network (e.g., the Internet).

The remote device 320 can execute instructions 424 to secure one or more data structures 310, responsive to a determination of a status of accessibility (e.g., inaccessibility) of the host device 306. For example, the remote device 320 can delete or encrypt one or more data structures 310, or generate a notification 514 (e.g., for delivery to the additional computing device 511 or another device associated with the cyber-forensic hub 322). The deletion or encryption can be repeated one or more times with a predefined or random pattern to sanitize data previously stored on a memory device, such as in the case of a spinning magnetic media exhibiting memory effects.

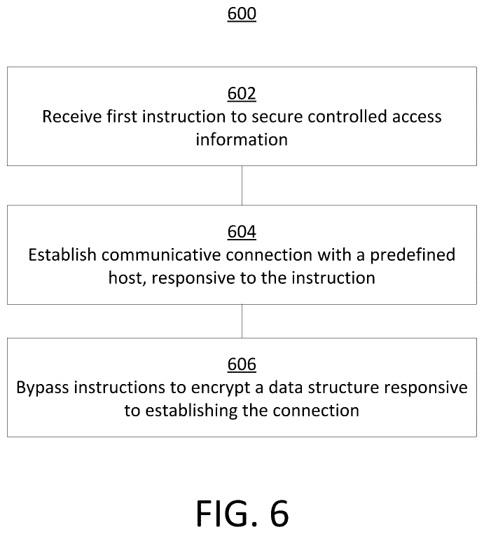

Referring now to FIG. 6, a method 600 of implementing data security measures is provided. The method 600 can be performed by one or more controllers 402 including various circuits, instructions, processors, or other logical elements, such as the logical elements described with respect to FIG. 1, the controller 402 of FIG. 4 or otherwise herein. For example, the controller 402 can be a controller 402 of the various systems disclosed herein. In brief overview, at operation 602, the method 600 includes receiving a first instruction 424 to secure controlled-access information. At operation 604, the method includes establishing a communicative connection with a predefined host, responsive to the receipt of the first instruction 424. At operation 606, the method includes bypassing, responsive to the establishment of the communicative connection, second instructions 424 accessible to the controller 402 to secure the data structure 310.

Referring again to operation 602, the controller 402 can receive a first instruction 424 to secure controlled-access information 422. The instruction 424 can be received from a network connected device, or from a local memory. For example, the instruction 424 can be received according to a periodic or other scheduled process, incident to an application opened by a user, or an interaction with a control element of a website. The execution of the instructions 424 can initiate one or more processes, such as processes corresponding to operation 604 and operation 606. In some embodiments, the instructions 424 can include more than one instruction set, of which at least one instructions set corresponds to a local controller 402, operating system, application, or other portion of a device configured to execute the instruction 424.

Referring again to operation 604, the controller 402 can establish a communicative connection with a predefined host (e.g., a host device 306 disposed on an enterprise network 302). For establishment can include determining that the communicative connection is present. The establishment of the communicative connection can be according to a receipt of a message confirming a communicative coupling with the host (e.g., a reply to a request previously sent by the controller 402, or a periodic or other message initiated at the host device 306). In some embodiments, the establishment of the communicative connection can include establishing a tunnel, such as a VPN session, SSH, or other connection with the host device 306. In some embodiments, the establishment of the communicative connection can include a transfer of one or more tokens, keys (e.g., encryption keys), or other identifiers to identify (e.g., authenticate) one or more of the device of the controller 402 or the host device 306.

Referring again to operation 606, the controller 402 can bypass second instructions 424 responsive to establishing the communicative connection. Bypassing the connections can include executing a branch away from the connections, servicing a delay clement (e.g., timer, loop, or so forth), or otherwise not executing the second instructions 424. The second instructions 424 can include instructions 424 to locate a data structure 310 corresponding to controlled-access information 422, and replacing such a data structure 310 with an encrypted data structure 310C. The data structure 310 can be local to a computing device including the controller 402 or in network communication therewith. The decryption (e.g., private) key may not be accessible to the controller 402. That is, the encryption can be configured to secure information, by encrypting data for which the controller lacks a decryption key. In some embodiments, the controller 402 can receive, prior to receiving the first instruction 424, a public key from the host device 306 (e.g., on the enterprise network 302, at disk imaging time, etc.). The public key may correspond to a private key local or otherwise accessible by the host device 306.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

The present disclosure may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, features or aspects within each example embodiment should typically be considered as available for other similar features or aspects in other example embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A method of digital rights management, the method comprising:
determining a status of an accessibility of a predefined host;
determining that a data structure corresponds to controlled-access information; and
responsive to the status indicating inaccessibility of the predefined host and the determination of the correspondence, encrypting the data structure to secure the controlled-access information.

2. The method of claim 1, wherein determining the data structure corresponds to the controlled-access information comprises:
comparing a file extension of the data structure to a predefined set of file extensions.

3. The method of claim 1, wherein determining the data structure corresponds to the controlled-access information is based on a location of the data structure within a file structure.

4. The method of claim 1, wherein determining the data structure corresponds to the controlled-access information is based on a comparison of a unique identifier of the data structure to a predefined list of unique identifiers.

5. The method of claim 1, further comprising:
sending an indication of the status indicating inaccessibility of the predefined host to a predefined address, comprising a source of the indication.

6. The method of claim 5, wherein:
the indication of the status indicating the inaccessibility of the predefined host comprises an email message; and
the predefined address corresponds to a law enforcement agency.

7. The method of claim 1, further comprising:
determining, responsive to the status indicating the inaccessibility of the predefined host, a status of an accessibility of a second predefined host, wherein the encryption of the data structure is responsive to a determination of the inaccessibility of the second predefined host.

8. The method of claim 1, wherein determining the status of the accessibility of the predefined host comprises:
sending a request for an indication of a presence of the predefined host; and
determining that a predefined time has elapsed from the request without receiving a response.

9. A system, comprising:
a first computing device configured to provide an indication of a communicative connection with a first set of network interfaces; and
a second computing device configured to:
determine a status of the communicative connection based on a receipt of the indication at a first network interface of the first set of network interfaces;
responsive to a determination that the communicative connection is present, bypass instructions to secure a data structure; and
responsive to a determination that the communicative connection is absent, execute the instructions, the instructions comprising instructions to secure the data structure.

10. The system of claim 9, wherein, to secure the data structure, the system is configured to:
encrypt the data structure according to an asymmetric encryption protocol.

11. The system of claim 10, wherein the second computing device is configured to encrypt the data structure with a public key, the public key corresponding to a private key of the first computing device.

12. The system of claim 9, wherein, to secure the data structure, the second computing device is configured to delete the data structure from a local memory.

13. The system of claim 9, wherein the first computing device is separated from a second set of network interfaces by a network firewall, the network firewall configured to firewall a network comprising:
the first computing device; and
the first set of network interfaces,
the network firewall being configured to block:
the indication of the communicative connection from the first computing device to the second set of network interfaces; or
a request from one or more of the second set of network interfaces to the first computing device.

14. A method, comprising:
receiving, by a controller, a first instruction to secure controlled-access information;
establishing, by the controller, a communicative connection with a predefined host, responsive to the receipt of the first instruction; and
bypassing, responsive to the establishment of the communicative connection, second instructions accessible to the controller to secure a data structure, the second instructions comprising instructions to:
locate the data structure corresponding to the controlled-access information; and
replace the data structure with an encrypted data structure.

15. The method of claim 14, wherein:
the data structure is local to the controller; and
a decryption key to decrypt the encrypted data structure is not accessible to the controller.

16. The method of claim 14, further comprising:
establishing, by the controller and subsequent to bypassing the instructions, an absence of the communicative connection; and
executing, by the controller, responsive to the absence of the communicative connection, the second instructions.

17. The method of claim 16, wherein the instructions to locate the data structure corresponding to the controlled-access information comprise:
comparing a file extension of the data structure to a predefined set of file extensions.

18. The method of claim 14, further comprising:
receiving, by the controller, a first encryption key to encrypt the data structure from the predefined host prior to the receipt of the first instruction.

19. The method of claim 14, wherein the first instruction is received, by the controller, automatically.

20. The method of claim 14, wherein:
the first instruction is received incident to an execution of an executable file stored on a same storage media as the second instructions; and
the second instructions to locate the data structure are based on a relative path between a location of the executable file and the data structure.
